(19) United States
(12) Patent Application Publication
(10) Pub. No.: US 2025/0200892 A1
(43) Pub. Date: Jun. 19, 2025

(54) METHODS AND SYSTEMS FOR GENERATING SURFACE FEATURE DATA

(71) Applicant: Toyota Jidosha Kabushiki Kaisha, Toyota-shi (JP)

(72) Inventor: Hadi Fadaifard, New York, NY (US)

(73) Assignee: Toyota Jidosha Kabushiki Kaisha, Toyota-shi (JP)

(21) Appl. No.: 18/541,656

(22) Filed: Dec. 15, 2023

(51) Int. Cl. G06T 17/20; G01S 17/894; G06T 5/30; G06T 5/77; G06T 7/90; G06T 11/00; G06T 17/05

(52) U.S. Cl. CPC G06T 17/20; G01S 17/894; G06T 5/30; G06T 5/77; G06T 7/90; G06T 11/00; G06T 17/05; G06T 2200/24; G06T 2207/10028; G06T 2207/30256; G06T 2210/56

(57) ABSTRACT

Methods and systems for generating surface feature data may include receiving a data set, extracting input layers from the data set, dilating and unionizing the input layers, and eroding and triangulating the input layers to generate a plurality of planar surfaces. The methods and systems may further include assigning heights to each vertex of the plurality of planar surfaces, detecting incomplete features in the plurality of planar surfaces, and filling the incomplete features in the plurality of planar surfaces.

### TECHNICAL FIELD

The present disclosure relates to computer-assisted processing technologies, and more particularly, to computer-assisted processing technologies for generating surface feature data.

### BACKGROUND

Three-dimensional maps include features derived from vector datasets resulting from light detection and ranging (LiDAR) scans of an environment. The LiDAR scan results in a point cloud of LiDAR points within the environment. Features, such as roads, buildings, signs and the like may be represented by polygons that consist of a collection of ordered, interconnected vertices. Aggregation of LiDAR data to generate accurate roadway features can be difficult and time-consuming, as width or the height of the roadway may vary. Moreover, there may be missing or incomplete data of the roadway. Therefore, a need exists for processing data to fill incomplete features of the roadway.

### SUMMARY

In an aspect of the present disclosure, a method for generating surface feature data includes receiving a data set, extracting input layers from the data set, dilating and unionizing the input layers, eroding and triangulating the input layers to generate a plurality of planar surfaces, assigning heights to each vertex of the plurality of planar surfaces, detecting incomplete features in the plurality of planar surfaces, and filling the incomplete features in the plurality of planar surfaces.

In another aspect of the present disclosure, a system for generating surface feature data includes a computing device comprising a memory component, wherein the memory component stores logic that, when executed by the computing device, causes the system to perform at least the following: receive a data set, extract input layers from the data set, dilate and unionize the input layers, erode and triangulate the input layers to generate a plurality of planar surfaces, assign heights to each vertex of the plurality of planar surfaces, detect incomplete features in the plurality of planar surfaces, and fill in the incomplete features in the plurality of planar surfaces.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative system for generating surface feature data, according to one or more embodiments shown and described herein;

FIG. 2. schematically depicts non-limiting components of the devices of the system for generating surface feature data, according to one or more embodiments shown and described herein;

FIG. 3A schematically depicts an example graphical representation of data points and input layers, according to one or more embodiments shown and described herein;

FIG. 3B schematically depicts an example graphical representation of input layers, according to one or more embodiments shown and described herein;

FIG. 4 schematically depicts an example graphical representation of dilated input layers, according to one or more embodiments shown and described herein;

FIG. 5 schematically depicts an example graphical representation of triangulated input layers, according to one or more embodiments shown and described herein;

FIG. 6A schematically depicts an example graphical representation of triangulated input layers with assigned heights, according to one or more embodiments shown and described herein;

FIG. 6B schematically depicts a side view of an example graphical representation of triangulated input layers with assigned heights, according to one or more embodiments shown and described herein;

FIG. 7A schematically depicts an example graphical representation of input layers with missing data, according to one or more embodiments shown and described herein;

FIG. 7B schematically depicts an example graphical representation of the input layers of FIG. 7A with missing data filled, according to one or more embodiments shown and described herein;

FIG. 8 schematically depicts an example graphical representation of mapped surface feature data, according to one or more embodiments shown and described herein; and

FIG. 9 schematically depicts a flow chart of an illustrative method for generating surface feature data, according to one or more embodiments shown and described herein.

### DETAILED DESCRIPTION

The embodiments described herein are directed to methods and systems for generating surface feature data, specifically, roadway surface feature data. The systems, methods, and computer implemented programs may utilize various algorithms and artificial intelligence for generating surface feature data.

Roadway maps may be generated by a user based on input data. However, it may be difficult and/or time consuming to generate specific surface feature data, such as the assignment of heights to various points/planes within the roadway. Moreover, it may be difficult or impossible for the user to generate accurate surface features if there is missing data. Thus, user generated surface feature may suffer from various inaccuracies, inefficiencies, and discontinuities.

The system for generating surface feature data includes eroding and triangulating input layers from a data set to generate a plurality of planar surfaces. Based on the LiDAR data, heights are assigned to each vertex of the plurality of planar surfaces. This may generate surface feature data with accurate three-dimensional points. Moreover, incomplete features in the plurality of planar surfaces may be filled using the systems and methods described herein.

As used herein, the singular forms “a,” “an” and “the” include plural referents unless the context clearly dictates otherwise. Thus, for example, reference to “a” component includes aspects having two or more such components unless the context clearly indicates otherwise.

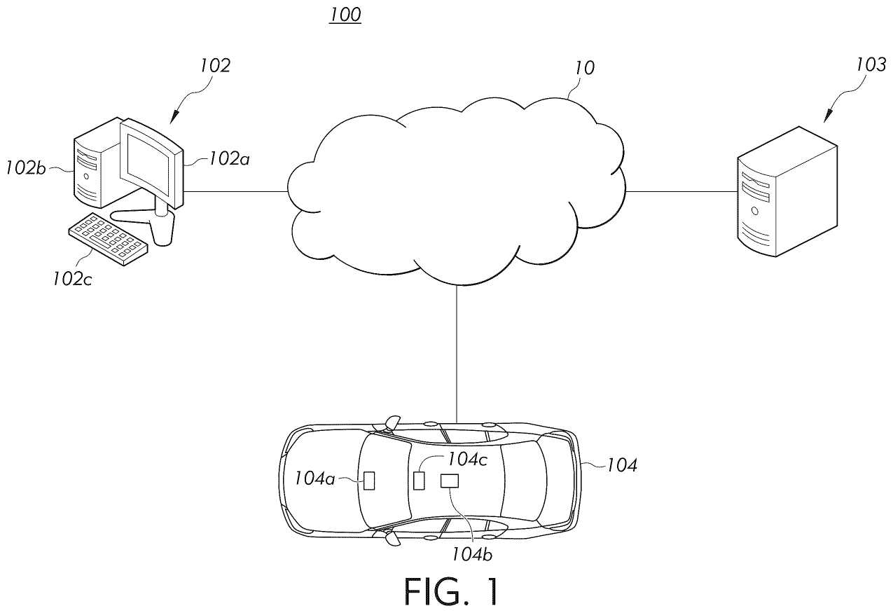

Referring to FIG. 1, an illustrative embodiment of a system 100 for generating surface feature data is depicted. The system 100 depicted in FIG. 1 includes a computing device 102, a server 103, and a vehicle 104 connected to each other via a network 10. As illustrated in FIG. 1, the network 10 may include a wide area network, such as the internet, a local area network (LAN), a mobile communications network, a public service telephone network (PSTN) and/or other network and may be configured to electronically connect a computing device 102, a server 103, and/or a vehicle 104.

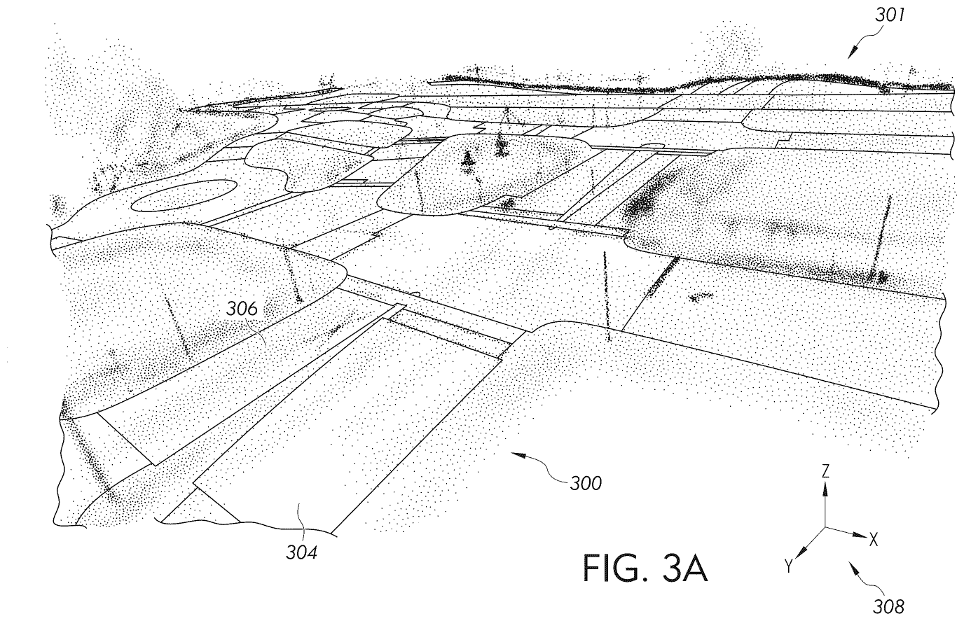

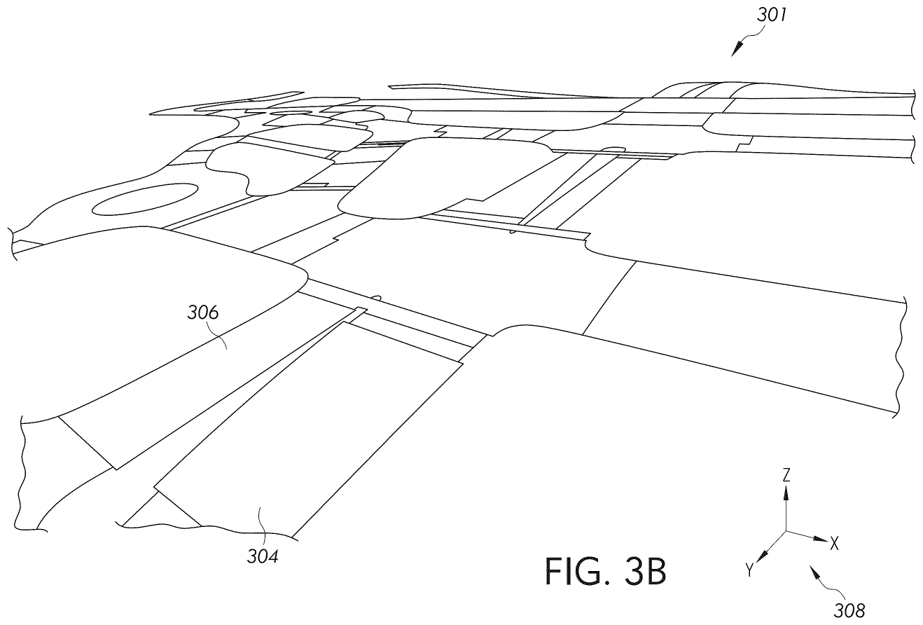

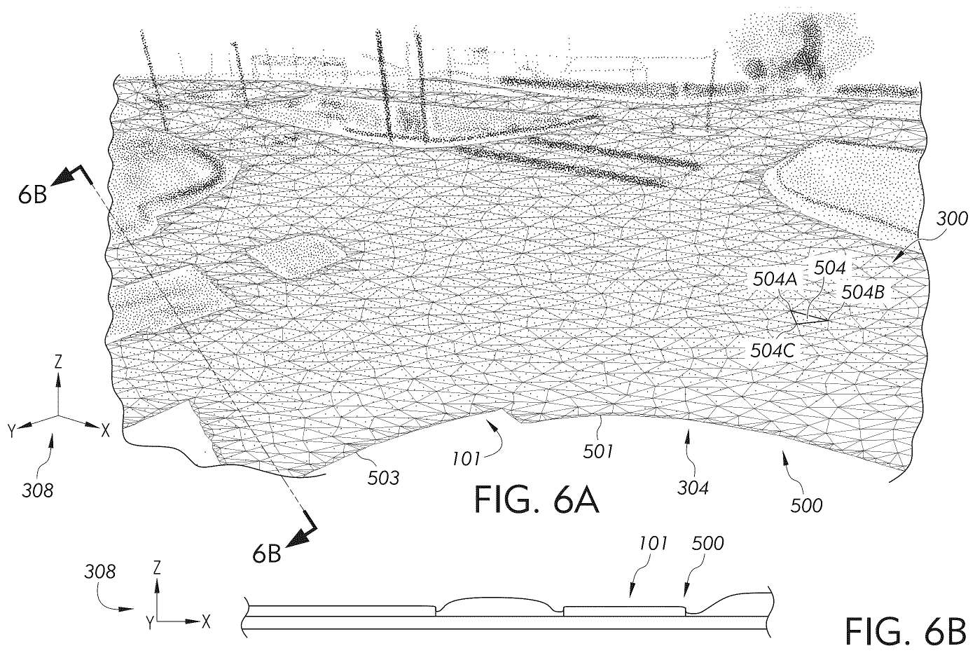

The computing device 102 may include a graphical user interface (GUI) 102a, a processor 102b and an input device 102c, each of which may be communicatively coupled to together and/or to the network 10. The server 103 may be configured to include similar components as the computing device 102. As described in more detail herein, the computing device 102 may be configured to receive a data set (e.g., LiDAR data) from the server 103 and/or the vehicle 104 and generate surface feature data 101 (as depicted in FIG. 6A) based on the received data set. Moreover, a user may generate input layers 306 (as depicted in FIG. 3A) representing features of a roadway. The user may generate the input layers 306 by utilizing the input device 102c of the computing device 102. The server 103 may also be configured to perform operations described herein with reference to the computing device 102.

It should be understood that the computing device 102, the server 103, and the electronic control unit 104a of the vehicle 104 may be a personal computer, a micro controller, or the like. Additionally, while each of the computing devices illustrated in FIG. 1 are depicted as single pieces of hardware, this is also an example. More specifically, each of the computing device 102, the server 103, and electronic control unit 104a may represent a plurality of computers, servers, databases, and the like. As such, the computing device 102 and/or the server 103 may receive LiDAR data from one vehicle 104, or a plurality of vehicles 104 and store the LiDAR data on a memory component 260 (discussed further herein below).

The vehicle 104 includes an electronic control unit 104a, a communications unit 104b, and a sensor 104c. The electronic control unit 104a may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device. The processor is communicatively coupled to the other components of the vehicle 104 by a communication bus. Accordingly, the communication bus may communicatively couple any number of processors with one another, and allow the components coupled to the communication bus to operate in a distributed computing environment. Specifically, each of the components may operate as a node that may send and/or receive data. It is further noted that the processor may comprise a single processor, multiple processors, or a system of processors.

The communications unit 104b of the vehicle 104 may include network interfaces for one or more of a plurality of different networks, protocols, or the like. For instance, the communications unit 104b may include one or more antennas (e.g., many in/many out (MIMO) antennas, etc.) that may allow for communication via Wi-Fi networks, IrDA, Bluetooth, Wireless USB, Z-Wave, ZigBee, near field communication (NFC), LTE, WiMAX, UMTS, CDMA, C-V2X, GSM interfaces may include Wi-Fi, xth generation cellular technology (e.g., 2G, 3G, 4G, 5G, etc.), WCDMA, LTE Advanced, or the like.

The electronic control unit 104a is configured to be communicatively coupled to one or more sensors 104c for detecting roadway data. The one or more sensors 104c may be any sensor capable of generating a data set that would assist in generating roadway surface features, such as but not limited to LiDAR sensors, radar sensors, ultrasonic sensors, or any other suitable sensor for generating roadway surface data points. The at least one sensor 104c may emit an array of infrared beams, and detect the return of the beams and their times of flight to generate a point cloud (e.g., data points 300) of LiDAR points in three-dimensional space (as depicted in FIG. 3A and discussed further below). The electronic control unit 104a and communications unit 104b may communicate the data generated by the sensor 104c to the computing device 102 and/or the server 103 through the network 10, or any other suitable communication path.

A data storage component 268 and/or the memory component 260 of the computing device 102 or a memory of the server 103 may store the data from the sensors 104c of the vehicle 104. In some embodiments, the computer and the server 103 may be communicatively connected to a plurality of vehicles 104, such that the memory of the computing device 102 and server 103 include data from each of the plurality of vehicles 104. The computing device 102 and server 103 may aggregate the data from the plurality of vehicles 104, such that the aggregated data may be used to generate more accurate surface feature data 101, as described further herein.

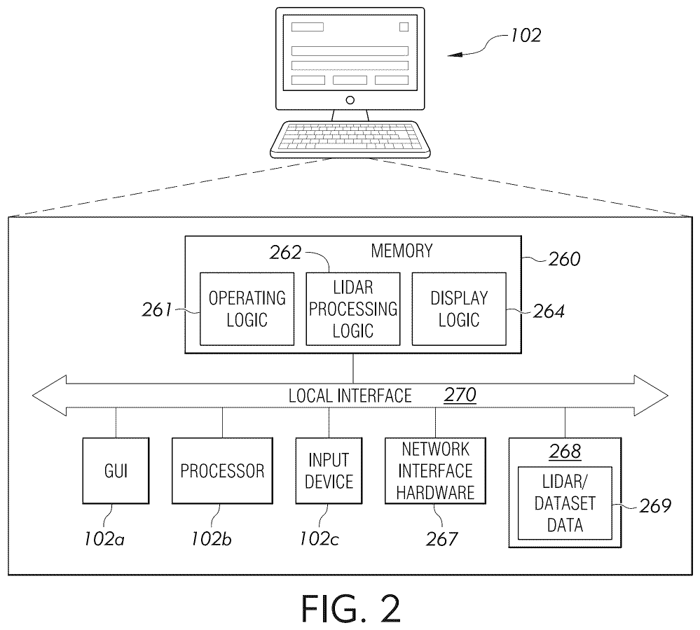

Referring now to FIG. 2, non-limiting components of the computing device 102 are depicted. While in some embodiments, the computing device 102 may be configured as a general purpose computer with the requisite hardware, software, and/or firmware, in some embodiments, the computing device 102 may be configured as a special purpose computer designed specifically for performing the functionality described herein. It should be understood that the software, hardware, and/or firmware components depicted in FIG. 2 may also be provided in other computing devices external to the computing device 102 (e.g., the server 103, data storage devices, remote server computing devices, and the like).

As depicted in FIG. 2, the computing device 102 (or other additional computing devices) may include various components, such as but not limited to the processor 102b, the graphical user interface 102a, the input device 102c, a network interface hardware 267, a data storage component 268 (which may include LiDAR data 269 or other data for performing the functionalities described herein), and a non-transitory memory component 260. The memory component 260 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 260 may be configured to store logic, such as but not limited to operating logic 261, LiDAR processing logic 262 for receiving and processing LiDAR data from the sensor 104c of the vehicle 104, and display logic 264 for displaying surface data on the GUI 102a, as described herein (each of which may be embodied as computer readable program code, firmware, or hardware, as an example). It should be understood that the data storage component 268 may reside local to and/or remote from the computing device 102, and may be configured to store one or more pieces of data for access by computing device 102 and/or other components.

A local interface 270 is also included in FIG. 2 and may be implemented as a bus or other interface to facilitate communication among the components of the computing device 102.

The processor 102b may include any processing component configured to receive and execute computer readable code instructions (such as from the data storage component 268 and/or memory component 260). The input device 102c may include one or more of graphics display device, keyboard, mouse, printer, camera, microphone, speaker, touch-screen, and/or other device for receiving, sending, and/or presenting data. The network interface hardware 267 may include any wired or wireless networking hardware, such as a modem, LAN port, wireless fidelity (Wi-Fi) card, WiMax card, mobile communications hardware, and/or other hardware for communicating with other networks and/or devices. The network interface hardware 267 may communicate via the Internet to receive the LiDAR data 269 provided from one or more sources (e.g., one or more sensors 104c of the vehicles 104) as well as communicate with a display device, such as the GUI 102a of the computing device 102 to display surface feature data 101.

Included in the memory component 260 may be the operating logic 261, LiDAR processing logic 262, and display logic 164. The operating logic 261 may include an operating system and/or other software for managing components of the computing device 102. Similarly, the LiDAR processing logic 262 may reside in the memory component 260 and may be configured to receive and process LiDAR data, such as to generate surface feature data 101. The display logic 264 includes logic to generate a display on the GUI 102a. The logic or algorithm(s) may be written in any programming language of any generation (e.g., 1GL, 2GL, 3GL, 4GL, or 5GL) such as, for example, machine language that may be directly executed by the processor 102b, or assembly language, object-oriented programming (OOP), scripting languages, microcode, etc., that may be compiled or assembled into machine readable instructions (e.g., logic) and stored in the memory component 260. It is noted that the aforementioned logics are referred to herein generally as “the logic,” which may refer to each of the logics recited above.

In embodiments, the logic set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 260 may be a machine-readable memory (which may also be referred to as a non-transitory processor-readable memory or medium) that stores instructions that, when executed by the processor 102b, causes the processor 102b to perform a method of generating surface feature data 101 as described herein.

The components illustrated in FIG. 2 are merely exemplary and are not intended to limit the scope of this disclosure. More specifically, while the components in FIG. 2 are illustrated as residing within the computing device 102 this is a non-limiting example. In some embodiments, one or more of the components may reside external to the computing device 102.

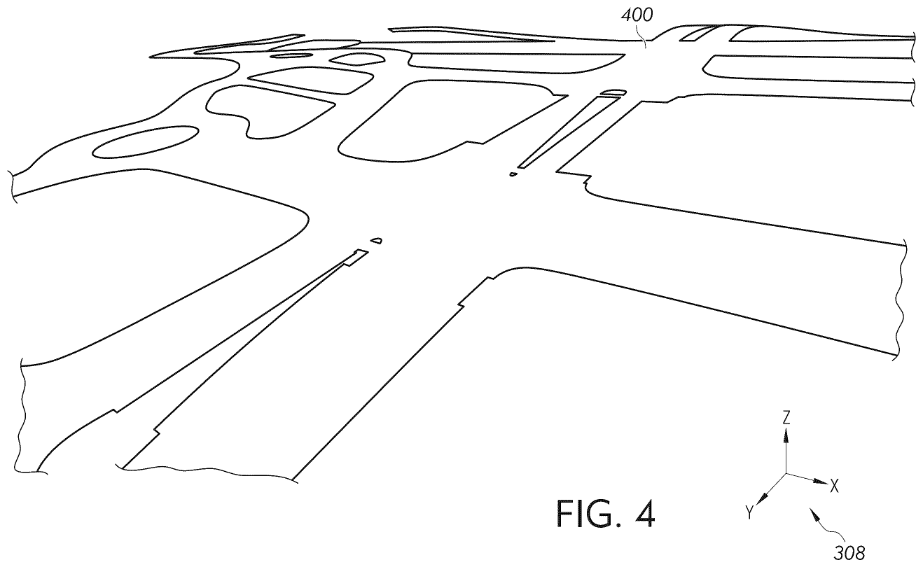

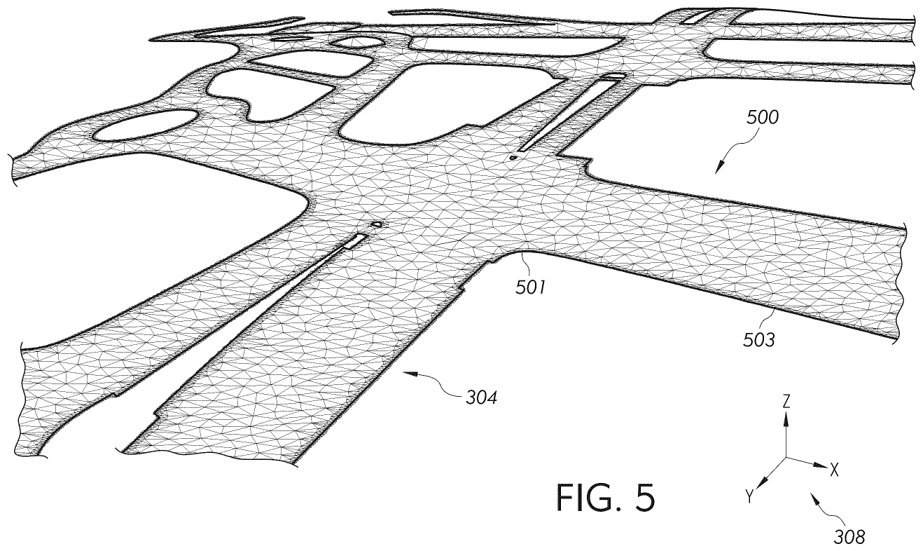

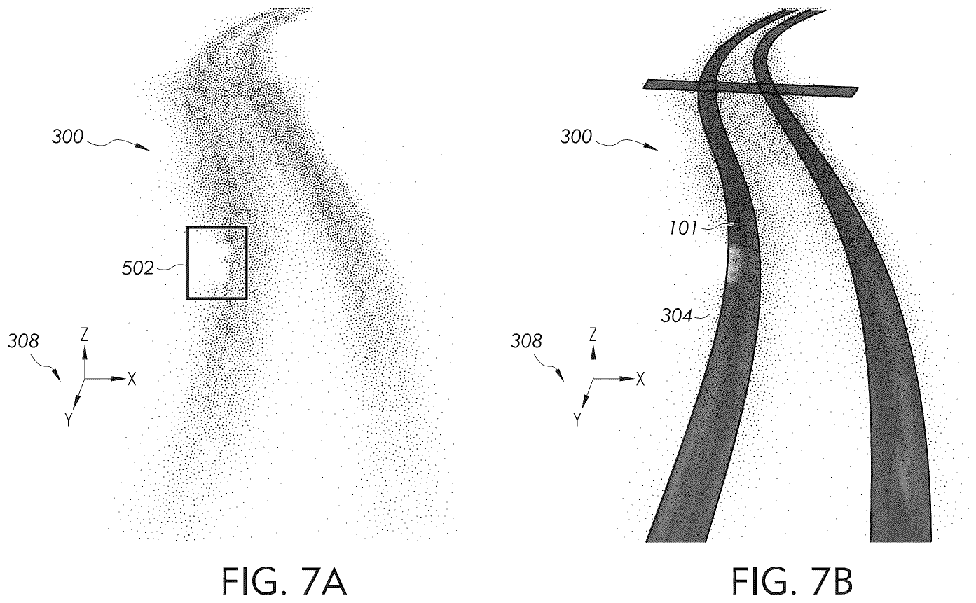

The logic stored on the memory component 260, when executed by the processor 102b, may cause the system 100 to receive a data set 300 (such as data points 300 or a plurality of data points from the LiDAR sensor 104c of the vehicle 104 described hereinabove). The logic may also cause the system 100 to extract input layers 306 from the data set 300 (depicted in FIGS. 3A and 3B) and dilate and unionize the input layers 306 (depicted in FIG. 4). The logic may further cause the system 100 to erode and triangulate the input layers 306 to generate a plurality of planar surfaces 500 (as depicted in FIG. 5). The logic may then cause the system 100 to assign heights to each vertex of the plurality of planar surfaces 500 and detect incomplete features 502 in the plurality of planar surfaces 500 and fill in the incomplete features 502 in the plurality of planar surfaces 500 (as depicted in FIGS. 7A-7B).

Referring now to FIGS. 3A and 3B, exemplary data points 300 (e.g., also referred to herein as data points 300) from LiDAR sensor of an environment 301 may be generated by the at least one sensor 104c (which may be a LiDAR scanning system). The data points 300 may include data points of input layers 306 (which may represent input layers of a roadway surface 304). In embodiments, the data points 300 may include points from objects in the environment 300 other than the roadway surface 304, such as but not limited to trees, buildings, street signs, traffic signals, curbs, lane lines, or any other object that may be within the environment 301. The data points 300 may be generated by a single vehicle sensor 104c mounted to a vehicle 104. In other embodiments, the data points 300 may be from a plurality of vehicle sensors 104c on multiple vehicles 104.

The data points 300 may include three-dimensional data points. For example, the data points 300 may be assigned Cartesian coordinates from the Cartesian coordinate system 308 depicted in FIGS. 3A and 3B. The Cartesian coordinates may be relative to an origin within the environment (such as at a center of the environment 301). Utilizing the Cartesian coordinate system 308, the environment 301 may be mapped in three-dimensional space.

The data points 300 may include intensity values. The intensity values of the LiDAR data 300 may correspond to a color of the roadway surface 304. For example, as discussed herein bellows, paint on the roadway surface 304 may be modeled as surface color features 322 through intensity values of the LiDAR data 300. The data points 300 may also include timestamp values. The timestamp values may include a time of when the data points 300 were acquired.

In embodiments, the input layers 306 may be mapped/generated by a user, such as by using the computing device 102 as described hereinabove. Once the data points 300 are received from the vehicle 104 through the network 10, the user may generate the input layers 306 by observing the data points 300. The input layers may represent a roadway surface 304. As such, for example, as depicted in FIG. 3A, the user may generate/map the roadway surface 304 utilizing the data points 300. The user may determine that a center of the roadway surface 304 corresponds to data points 300 representing a dashed line. The user may ignore data points 300 of any objects, such as trees or buildings, that do not correspond to the roadway surface 304. As such, the user may generate the input layers 306 similar to that depicted in FIG. 3B, which represent the roadway surface 304.

In embodiments, the input layers 306 and, thus, the roadway surface 304, may also be auto-generated by the computing device 102. For example, as depicted in FIG. 2 and discussed hereinabove, the memory component 260 may include the LiDAR processing logic 262 for receiving and processing LiDAR data from the sensor 104c of the vehicle 104. The LiDAR processing logic 262 may automatically distinguish data points 300 associated with the roadway 304 and data points 300 associated with objects other than the roadway (such as trees, buildings, or cars). The input layers 306 generated from the data points 300 are depicted in FIG. 3B. The input layers 306 may be two-dimensional in nature and, thus, may not accurately reflect heights and/or imperfections on the roadway surface 304. As such, the input layers 306 may be dilated, eroded to planar surfaces 500, and heights may be assigned on each of the planar surfaces 500 to more accurately reflect the roadway surface 304, as described further herein.

As depicted in FIG. 3B, there may be multiple input layers 306. Thus, although the input layers 306 represent the roadway surface 304 when put side-by side as depicted in FIG. 3B, each of the input layers 306 taken individually may only represent a small portion of the roadway surface 304. Once the input layers 306 are extracted from the data set 300, the system 100 may dilate and unionize the input layers 306.

The input layers 306 may be dilated and unionized by the system 100, such as to generate the unionized input layer 400, as depicted in FIG. 4. The input layers 306 may be dilated until each of the adjacent input layers 306 are overlapping. The input layers 306 may then be unionized, to generate the single, unionized input layer 400, as depicted in FIG. 4. The unionized input layer 400 is a single planar surface, combining the individual input layers 306 into the unionized input layer 400.

The logic may further cause the system 100 to erode and triangulate the input layers 306 (e.g., the unionized input layer 400) to generate a plurality of planar surfaces 500, as depicted in FIG. 5. The dilation described above may be undone/reversed in order to have a more accurate representation of the roadway surface 304, while maintaining the unionization of the input layers 306. The input layers 306 may be eroded to a geometry that reflects boundaries of the input layers 306 before the input layers 306 were dilated, such as to more accurately reflect dimensions of the roadway surface 304.

The input layers 306 may be triangulated and, thus, be divided into a plurality of 2-dimensional triangular planar surfaces 500 that that graphically represent the roadway surface 304. The input layers may be divided into triangular planes (as depicted in FIG. 5), rectangular planes, square planes, or any other polygonal plane. Distance between vertices of the planar surfaces 500 may be adjusted, such as by dividing the input layers 306 into smaller and, thus, more planar surfaces 500. The distance between vertices of the planar surfaces 500 may be determined by a desired resolution of a resulting model. A lower distance between vertices of planar surfaces 500 may generally correspond to a higher resolution and, thus, a more accurate modeling of the surface features/roadway surface 304 when the planar surfaces 500 are assigned heights, as discussed further below. In embodiments, the planar surfaces 500 may have a distance between each vertex (i.e., a resolution) of 0.1 meters, 0.5 meters, 1 meter, 2 meters, 3 meters, or any other suitable distance.

The planar surfaces 500 may be evenly distributed. In other embodiments, there may be a higher number of the planar surfaces 500 at a curve 501 or edge 503 of the roadway surface 304 in order to capture characteristics (such as heights at the curvature, as explained further below) of the curve 501 or edge 503 more accurately.

As the planar surfaces 500 are 2-dimensional, the memory component 260 may further include logic that causes the system 100 to assign heights to each vertex planar surface 500, as depicted in FIGS. 6A and 6B. As the planar surfaces 500 correspond to a surface of the x-y plane depicted in FIGS. 6A and 6B, heights may be assigned to the planar surfaces 500 in the z-direction, resulting in a generation of the surface feature data 101, such as a three-dimensional model of the roadway surface 304. FIG. 6A depicts a perspective view of an example graphical representation of triangulated input layers with assigned heights. Heights may be assigned to a center of each planar surface 500. In other embodiments, heights may be assigned to each vertex of the planar surface 500. As such, when the planar surfaces 500 are triangular, heights may be assigned to each of the three vertices of each planar surface 500. FIG. 6B depicts a side-view of heights assigned to the vertices of the planar surfaces 500. The vertices of the planar surfaces 500 may be assigned heights below, at or above the x-y plane.

In embodiments, heights may be assigned to each vertex of the planar surfaces 500 through the Cartesian coordinates of three-dimensional points in the data set. As noted hereinabove, the data points 300 may correspond to Cartesian coordinates from the Cartesian coordinate system 308. To assign heights to each of the vertices of the planar surfaces 500, the system 100 may include logic that overlays the data points 300 onto the planar surfaces 500, as depicted in FIG. 6A. The logic then determines the data point 300 closest to each of the vertices of the planar surfaces 500. Each vertex may then be assigned a height based on the height (i.e., z-value) of the closest data point 300 to the vertex.

For example, a first planar surface 504 may include three vertices, 504A, 504B, and 504C. Each of the vertices may be assigned different height values in the z-direction of the Cartesian coordinate system 308 because the heights of the closest data point 300 for each vertex may be different. In some embodiments, one or more vertices of the planar surfaces 500 may share the same height, such as when the vertices share a closest data point 300. Such sharing of the closest data point 300 may occur when there is a high resolution of planar surfaces 500 and, thus, the vertices of the planar surfaces 500 are close to one another.

In embodiments, heights may be assigned to each vertex based on an average z-value of the data points 300 surrounding the vertex. A threshold number of data points may be used to determine the height assigned to the vertex. In embodiments, the threshold number of data points may be 25, 50, 100, 150, 200, 300, 400 or 500 data points 300, such that the closest data points 300 to the vertex under the threshold number of data points may be used to calculate the height assigned to the vertex. In other embodiments, data points 300 within a threshold distance of the vertices may be averaged to assign heights to the vertices of the planar surfaces 500. In embodiments, the threshold distance from the vertices used to assign heights to the vertices may be less than or equal to 50 millimeters, less than or equal to 60 millimeters, less than or equal to 75 millimeters, less than or equal to 100 millimeters, less than or equal to 150 millimeters, less than or equal to 200 millimeters, or less than or equal to 500 millimeters. As such, the height of each vertex may correspond to an average height of each data point 300 within the threshold distance from the vertex.

Each data point 300 used to calculate the height assigned to the vertex of the planar surface 500 may carry equal weight in determining the height assigned to the vertex of each planar surface 500. As such, the assigned height to each vertex may be the average of the heights (i.e., z-values) of each data point 300 within the threshold distance from each vertex of the planar surfaces 500. In other embodiments, weights may be assigned to each data point 300 within the threshold distance of each vertex. Weights assigned to each data point 300 may correspond to how close the data point is to the vertex of the planar surface 500. As such, a data point 300 may be assigned a high weight when calculating the height assigned to the vertex of each planar surface 500 when the data point is at or near the vertex. In contrast, data points 300 that are further from the vertex of the planar surface 500, such as those data points 300 that are near the threshold distance from the vertex.

In embodiments, if a data point 300 is directly above or below the vertex of the planar surface 500, such that the data point 300 has the same or near the same x-y coordinates as the vertex, the data point 300 may carry 80%, 85%, 90%, 95%, 97%, or 98%, 99% or 100% of the weight assigned to the height of the vertex since it is likely that the data point 300 that shares the same x-y coordinates as the vertex is a point on the roadway surface 304.

The logic may further cause the system 100 to detect incomplete features 502 in the plurality of planar surfaces 500, as depicted in FIG. 7A. Incomplete features 502 may include incomplete data points 300 and, thus, the failure of the system 100 to assign heights to vertices of vertices of the planar surfaces 500. The incomplete features 502 may be an area in which the LiDAR sensor 104c did not capture any data points 300. The incomplete features 502 may be due to a pothole in the roadway surface 304, an area in which a car was parked while the LiDAR sensor was detecting points on the roadway surface 304, or any other object/imperfection on the roadway surface 304 that may result in incomplete features on the plurality of planar surfaces 500.

The memory component 260 may further include logic that causes the system 100 to fill in the incomplete features 502 in the planar surfaces 500, as depicted in FIG. 7B. Thus, the roadway surface 304 may be accurately modeled even with the missing data points. The system 100 may fill the incomplete features in the planar surfaces 500 via a discrete differential geometry algorithm, such as a discrete differential geometry algorithm utilizing a Laplace operator. The incomplete features 502 may also be filled by solving a Poisson equation. In embodiments, the incomplete features 502 of the planar surfaces 500 are filled such that there are no discontinuities within the roadway surface 304, as depicted in FIG. 7B.

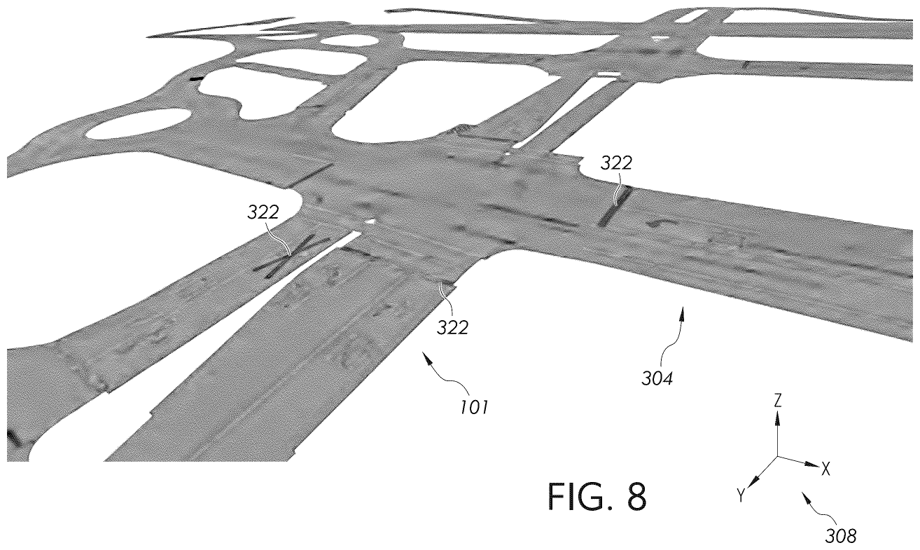

Referring now to FIG. 8, the system 100 may also detect surface color features 322 through the intensity values of the data points 300. For example, the system 100 may include the surface color features 322 on the surface feature data 101, such as surface color features 322 of the roadway surface 304. The surface color features 322 may indicate crosswalks, railroad crossings, lane lines, stop lines, or any other surface color feature that may be painted on a roadway surface 304.

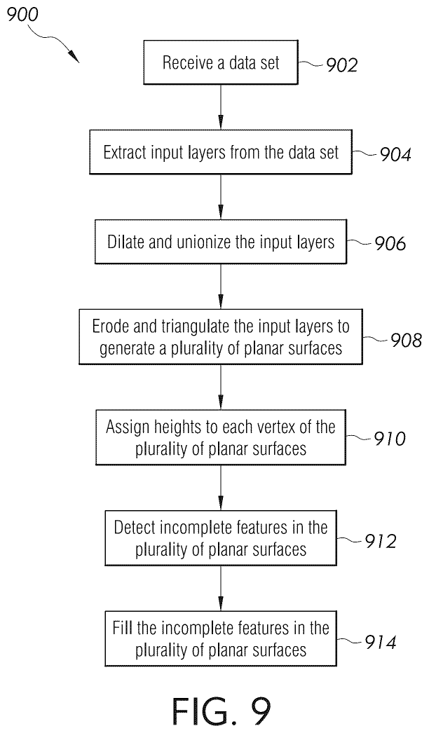

Referring to FIG. 9, a flow diagram of a method 900 of generating surface feature data 101 is depicted. At block 902, the data set 300 may be received. At block 904, input layers 306 may be extracted from a data set 300. At block 906, the input layers 306 may be dilated and unionized. Moreover, at block 908, the input layers 306 may be eroded and triangulated to generate the plurality of planar surfaces 500. At block 910, heights are assigned to each vertex of the plurality of planar surfaces 500 and at block 912, the incomplete features are detected in the plurality of planar surfaces 500. At block 914, the incomplete features in the plurality of planar surfaces 500 are filled. Specifically, the method 900 may include filling in the incomplete features of the planar surfaces 500 with an algorithm utilizing a Laplace operator, or any other suitable algorithm, as described above.

The method 900 may further include detecting the surface color features 322 through the intensity values of the data points 300. The method 900 may also include generating the two-dimensional model of the surface feature data 101 through the plurality of planar surfaces 500 and generating the three-dimensional model of the surface features data 101 through assigning heights to each vertex of the planar surfaces 500.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of generating surface feature data, the method comprising:
receiving a data set;
extracting input layers from the data set;
dilating and unionizing the input layers;
eroding and triangulating the input layers to generate a plurality of planar surfaces;
assigning heights to each vertex of the plurality of planar surfaces;
detecting incomplete features in the plurality of planar surfaces; and
filling the incomplete features in the plurality of planar surfaces.

2. The method of claim 1, wherein the data set includes a plurality of data points from LiDAR sensor data.

3. The method of claim 1, wherein the input layers represent a roadway surface.

4. The method of claim 3, wherein a distance between vertices of the plurality of planar surfaces are smaller on a roadway surface edge.

5. The method of claim 3, wherein the incomplete features in the plurality of planar surfaces are roadway imperfections or potholes in the roadway surface.

6. The method of claim 1, wherein the data set includes a plurality of data points, wherein each of the plurality of data points includes Cartesian coordinates, intensity values, and timestamp values.

7. The method of claim 6, further comprising detecting surface color features through the intensity values of the plurality of data points.

8. The method of claim 7, wherein the surface color features are road paint features of a roadway.

9. The method of claim 6, wherein the heights are assigned to each vertex of the plurality of planar surfaces through the Cartesian coordinates of three-dimensional points in the data set.

10. The method of claim 1, further comprising:
generating a two-dimensional model of the surface feature data based on the data set; and
generating a three-dimensional model of the surface feature data based on the data set.

11. The method of claim 1, further comprising filling the incomplete features in the plurality of planar surfaces with an algorithm utilizing a Laplace operator.

12. A system for generating surface feature data, the system comprising a computing device comprising a processor and a memory component, wherein the memory component stores logic that, when executed by the processor, causes the system to perform at least the following:
receive a data set;
extract input layers from the data set;
dilate and unionize the input layers;
erode and triangulate the input layers to generate a plurality of planar surfaces;
assign heights to each vertex of the plurality of planar surfaces;
detect incomplete features in the plurality of planar surfaces; and
fill in the incomplete features in the plurality of planar surfaces.

13. The system of claim 12, wherein the data set includes a plurality of data points from LiDAR sensor data of a roadway.

14. The system of claim 12, further comprising a graphical user interface communicatively coupled to the processor, wherein the system further displays a three-dimensional model of the surface feature data on the graphical user interface.

15. The system of claim 12, wherein a distance between vertices of the plurality of planar surfaces may be adjusted.

16. The system of claim 12, wherein the input layers represent a roadway surface.

17. The system of claim 12, wherein the incomplete features in the plurality of planar surfaces are imperfections or potholes in a roadway surface.

18. The system of claim 12, wherein the data set includes a plurality of data points, wherein each of the plurality of data points includes Cartesian coordinates, intensity values, and timestamp values.

19. The system of claim 18, wherein the system further detects surface color features through the intensity values of the plurality of data points.

20. The system of claim 19, wherein the surface color features are road paint features of a roadway.
